(19) United States
(12) Patent Application Publication
(10) Pub. No.: US 2016/0131607 A1
(43) Pub. Date: May 12, 2016

(54) METHOD OF COMBINED USE OF INFRARED CAMERA, NON-CONTACT INFRARED SENSOR, OR CONTACT TEMPERATURE SENSOR WITH INSULATION RESISTANCE TESTER FOR AUTOMATIC TEMPERATURE NORMALIZATION

(71) Applicant: Fluke Corporation, Everett, WA (US)

(72) Inventors: Luis R. Silva, Everett, WA (US); Michael D. Stuart, Issaquah, WA (US)

(21) Appl. No.: 14/856,027

(22) Filed: Sep. 16, 2015

Related U.S. Application Data
(60) Provisional application No. 62/076,060, filed on Nov. 6, 2014.

(51) Int. Cl. G01N 27/04; G01N 21/3563

(52) U.S. Cl. CPC G01N 27/046; G01N 21/3563

(57) ABSTRACT

Systems can include a resistance testing device configured to generate resistance data regarding the insulation resistance of equipment under test and a temperature sensing device configured to generate temperature data regarding the temperature of the equipment under test. The system can include a processor configured to receive the resistance data and the temperature data. Based on the received data, the processor can determine normalized resistance data accounting for temperature effects on the measured resistance. Normalized resistance data can indicate a predicted value for the insulation resistance measurement had the measurement been performed at a reference temperature. Thus, insulation resistance values normalized to a common temperature can be more accurately and meaningfully analyzed and trended over time.

### CROSS-REFERENCES

This application claims the benefit of U.S. Provisional Application No. 62/076,060, filed Nov. 6, 2014, the content of which is hereby incorporated by reference in its entirety.

### BACKGROUND

Insulating elements are used in many environments to prohibit unwanted flow of electricity. For example, a plurality of bundled conductive cables installed during construction may rely on insulation (e.g., an insulative coating) between the conductors to isolate the power or signals on each conductor. Similarly, insulation between the conductors and ground can prevent unwanted or dangerous shorts to ground. In other examples, conductors in motor windings may be coated in an insulating material to prevent shorts.

In general, the resistance of insulating elements such as coatings for conductive wires can be measured before, after, or between uses of electrical equipment to ensure that they are properly insulating to prevent undesired electrical conduction or shorts between various components. However, measurements of insulation resistance are not always performed in the same environment or under the same conditions. For instance, an insulation resistance measurement of an object under test can be measured during winter, when ambient air is generally cooler than in the summer. The cooler ambient air temperature can result in a cooler insulating element when compared to the temperature of the insulating element in the summer. Accordingly, measurements of the insulation resistance in the winter and the summer can be performed with the insulating element at different temperatures. In another example, an insulating element of an object may rise in temperature during operation of the object. Accordingly, the temperature of the insulating element may be higher during an insulation resistance measurement soon after device operation when compared to the temperature of the insulating element when the device has been idle for an extended period of time.

Such changes in temperature can cause variation in the insulation resistance measurement. Accordingly, insulation resistance measurements performed at different times can similarly be performed at different temperatures, yielding inconsistent results. As a result, comparisons of various insulation resistance measurements may not be accurate. Similarly, it can be difficult to observe trends in the insulation resistance over time.

### SUMMARY

Embodiments of the invention generally relate to systems and methods for determining and compensating for effects of temperature on insulation resistance. Exemplary systems include a resistance testing device configured to generate resistance data regarding the insulation resistance of equipment under test. Systems can further include a temperature sensing device configured to generate temperature data regarding the temperature of the equipment under test. A processor can be configured to receive resistance data and temperature data and determine, based on the received resistance data and temperature data, normalized resistance data. The normalized resistance data can account for temperature effects on the measured resistance.

In some examples, the normalized resistance data is based on a reference temperature. That is, the normalized resistance data is representative of a resistance value that would have been measured at a reference temperature. In some examples, the normalized resistance data can be determined using the acquired resistance data, acquired temperature data, and a reference temperature value. The normalized resistance value can be determined, for example, via an equation or a lookup table.

Exemplary systems can include a user interface by which a user can enter or receive information. In some embodiments, a user can input any number of parameters, such as temperature data, object under test information, a reference temperature, and the like.

Systems can include an external device such as a smartphone, tablet, computer, or the like that can perform some or all of the processing steps. In some examples, the external device includes a display for displaying any one or more of resistance data, temperature data, and normalized resistance data. In some examples, an external device can wirelessly receive data from the insulation resistance testing tool and/or the temperature measurement device.

Normalized resistance data associated with particular equipment under test can be stored in memory. In some examples, the normalized resistance data can be stored in memory and associated with the particular equipment under test for future recall and analysis. In some embodiments, different normalized resistance data for the particular equipment under test can be associated with the equipment under test and compared/trended over time.

### BRIEF DESCRIPTION OF THE DRAWINGS

FIG. 1 is a view of an exemplary test and measurement tool configured to acquire both insulation resistance data and temperature data.

FIG. 2 is a schematic representation of a system including test tool incorporating both a temperature sensing device and a resistance testing device.

FIG. 3 is a flow diagram illustrating an exemplary process for compensating resistance data with temperature data using an external device.

FIG. 4 is a process flow diagram outlining an exemplary process performed by a test tool capable of acquiring both temperature and insulation resistance data.

FIG. 5 shows an exemplary method for a combination of automated and manual temperature compensation for an insulation resistance test using an external device.

FIGS. 6-11 are exemplary process flow diagrams showing different processes for acquiring and combining temperature and insulation resistance data for determining a normalized insulation resistance value.

### DETAILED DESCRIPTION

Often, insulation resistance varies predictably with temperature. Accordingly, knowing the temperature of the insulating element or other equipment in close proximity thereto while performing the insulation resistance measurement can provide a more meaningful and consistent determination of the insulation resistance. Some embodiments of the present invention include test tools comprising a resistance testing device and a temperature sensing device. For example, embodiments of a test tool can include a digital multimeter (DMM) configured to measure the insulation resistance of an object under test. Embodiments can include any or all of an infrared (IR) imaging device for capturing IR image data from a target scene representative of temperatures therein or other non-contact temperature measurement device (e.g., a pyrometer, thin-film electro-resistive device, thermopile, or infrared-sensitive microbolometer or array, or contact temperature measurement devices (e.g., thermistor, thermocouple, resistive temperature device, etc.). In embodiments including an IR imaging device the test tool can further include a visible light (VL) imaging device for acquiring VL image data of the target scene. The IR and VL imaging devices can be used together, for example as described in U.S. Pat. No. 7,535,002, entitled “CAMERA WITH VISIBLE LIGHT AND INFRARED BLENDING,” which is assigned to the assignee of the instant application, and which is hereby incorporated by reference in its entirety.

In some examples, the resistance testing device and the temperature sensing device are included in the same test tool. For example, embodiments can include combined imaging tools (e.g., IR imaging device, VL imaging device) and test and measurement tools (e.g., DMM) such as those described in U.S. patent application Ser. No. 14/855,884, filed Sep. 16, 2015, and entitled “TEST AND MEASUREMENT SYSTEM WITH REMOVABLE IMAGING TOOL,” which is assigned to the assignee of the instant application, and which is hereby incorporated by reference in its entirety. In other examples, embodiments include a system comprising a separate resistance testing device and temperature sensing device. In some such embodiments, separate resistance testing devices and temperature sensing devices can be in communication with one another via wired or wireless communication. Additionally or alternatively, each of the resistance testing device and the temperature sensing device can be in wired or wireless communication with a an external device such as a smartphone, tablet, computer, or other appropriate device for performing one or both of displaying and analyzing resistance and temperature data, as described for example, in U.S. patent application Ser. No. 14/855,989, filed Sep. 16, 2015, and entitled “DISPLAY OF IMAGES FROM AN IMAGING TOOL EMBEDDED OR ATTACHED TO A TEST AND MEASUREMENT TOOL,” which is assigned to the assignee of the instant application, and which is hereby incorporated by reference in its entirety.

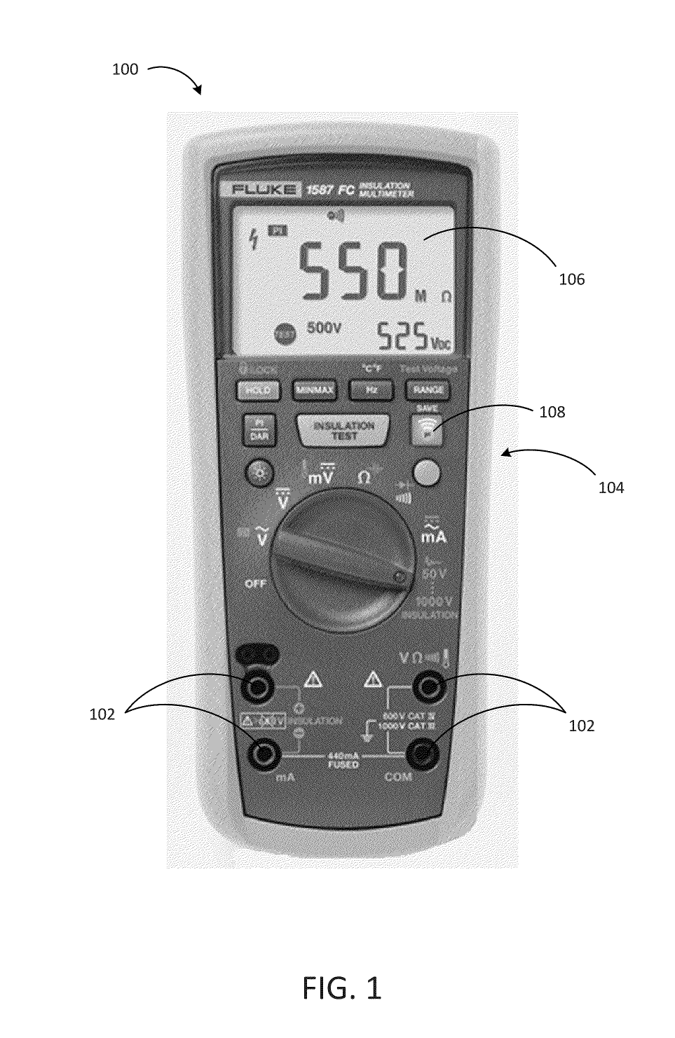

FIG. 1 is a view of an exemplary test and measurement tool configured to acquire both insulation resistance data and temperature data. In the illustrated example, a test and measurement tool 100 includes inputs 102 for receiving input leads configured to interface with an object under test. Various inputs 102 may be electrically isolated, or may be connected, for example, by a fuse, for facilitate measurements of various parameters of an object under test. For instance, different inputs 102 may be utilized by a user wishing to measure a voltage and a current using the test and measurement tool 100, since measuring such parameters typically requires different properties of test leads (e.g., isolated to measure across portions of a circuit vs. conductive/fused to break the circuit).

The test and measurement tool 100 of FIG. 1 includes an interface 104 for receiving inputs from a user. In the illustrated embodiment, the interface 104 includes a rotary switch and a variety of buttons actuatable by a user in order to adjust various operating parameters of the test and measurement tool 100. The test and measurement tool 100 further includes a display 106 for presenting information to a user. The presented information can include a variety of information. For example, in some embodiments, the display 106 can communicate measurement data to a user, units in which the measurement data is measured, a mode of operation of the test and measurement tool, a communication status of the test and measurement tool, appropriate input or output operating ranges of the test and measurement tool, alarm or error warnings, and other information that may be useful to a user using the test and measurement tool 100.

In various examples, a test and measurement tool such as 100 shown in FIG. 1 may be used for performing one or both of a temperature measurement and an insulation resistance measurement. An exemplary test and measurement tool capable of performing such measurements is the Fluke® 1587 Insulation Multimeter, the User's Manual of which can be found at http://media.fluke.com/documents/15x7_umeng0200.pdf and which is hereby incorporated by reference in its entirety.

In various examples, the test and measurement tool may be capable of interfacing with a contact or non-contact temperature sensing device for determining a temperature of an object under test. For example, in some embodiments, the test and measurement tool can interface with a thermocouple and determine the temperature of an object under test being sensed by the thermocouple. During operation of an exemplary test and measurement tool 100, a user can couple leads of a thermocouple into inputs 102 and select a temperature measurement function via the interface 104 (e.g., via rotary switch). In some examples, a user may adjust various parameters via interface 104, such as temperature units (e.g., ° C., ° F., etc.), type of thermocouple, and the like. The test and measurement tool 100 can present a temperature reading on the display 106 representative of the temperature of an object under test.

Additionally or alternatively, the test and measurement tool can be capable of performing an insulation resistance test. In some such examples, the test and measurement tool can be configured to apply a voltage of appropriate magnitude for performing the measurement. In some instances, the appropriate voltage is based on suggested guidelines for measuring the insulation resistance, for example, applying approximately twice the typical operating voltage of the object under test.

During an exemplary insulation resistance measurement, a user can insert test probes in appropriate inputs 102 on the test and measurement tool 100 and adjust the interface 104 (e.g., the rotary switch) to enable insulation resistance testing. In some examples, a user may select an application voltage to be used for the insulation resistance test. The user can remove power from the object under test and connect the probes thereto. In some examples, the test and measurement tool 100 may determine if the object under test is energized and can alert the user to remove power from the device. Once the probes are attached to the unpowered object under test, a user can initiate the resistance measurement test via the interface 104 (e.g., via a button or the like). When the test is initiated, the test and measurement tool 100 may provide a voltage to the object under test (e.g., the user-selected voltage). The display 106 can present the user with information, such as any one or more of the applied test voltage, a desired test voltage or test voltage range, and a measured insulation resistance. For example, the display 106 can include a primary display and a secondary display. In the illustrated example of FIG. 1, the display 106 includes a primary display indicating an insulation resistance measurement (550 MΩ) and a secondary display indicating the applied voltage (525 V_{DC}) and a desired application voltage range (500V).

As described elsewhere herein, test and measurement tool 100 can communicate with an external device such as a smartphone, tablet, computer, or the like. In some examples, the external device may include software or other capabilities for performing any one or more of receiving, saving, and displaying received information. For example, in some embodiments, the external device can show measurements from the test and measurement tool 100 on a screen, save measurements to an equipment log associated with the object under test, and/or share received information with other devices.

In some examples, the interface 104 of the test and measurement tool 100 includes a radio button 108 configured to active a communication channel for transmitting information from the test and measurement tool 100 to an external device. In some examples, the communication can be wired or wireless communication (e.g., Bluetooth, Wi-Fi, Zigbee, RF communication, IR communication, etc.). In an exemplary operation, a user can activate the communication channel of the test and measurement tool 100 (e.g., via radio button 108 on interface 104) and enable communication (e.g., Bluetooth communication) on the external device. The user may open an appropriate application (“app”) or other software program on the external device and select the test and measurement tool 100 from a list of connected devices. Upon selecting the test and measurement tool 100, measurement data generated by the tool can be acquired, displayed, saved, and shared using the external device.

In various examples, communication between an external device and a test and measurement tool can be as described, for example, in U.S. Patent Publication No. 20140278259, corresponding to U.S. patent application Ser. No. 14/214,600, filed Mar. 14, 2014, and entitled “CAPTURE AND ASSOCIATION OF MEASUREMENT DATA,” and U.S. Patent Publication No. 20140270546, corresponding to U.S. patent application Ser. No. 14/214,624, filed Mar. 14, 2014, and entitled “UNIFIED DATA COLLECTION AND REPORTING INTERFACE FOR EQUIPMENT,” each of which is assigned to the assignee of the instant application, and is hereby incorporated by reference in its entirety.

During operation, the temperature sensing device can generate temperature data regarding an apparent temperature of electrical or electro-mechanical equipment under an insulation resistance measurement test. Similarly, the resistance testing device can generate resistance data from the insulation resistance measurement test. In some examples, the temperature data can be transmitted to the resistance testing device for the combination of the temperature data and the resistance data. In other embodiments, resistance data can be transmitted to the temperature sensing device, or both the temperature data and the resistance data can be transmitted to another common location, such as memory or a processor (e.g., an external device) separate from the two devices. In embodiments in which the resistance testing device and the temperature sensing device are integrated into a single device, temperature and resistance data can be stored in an internal memory or sent to an internal processor.

In some examples, the temperature data and the resistance data can be combined to determine normalized resistance data, in which an insulation resistance measurement is normalized to a reference temperature. That is, a resistance measurement taken at a first temperature can be adjusted to reflect the resistance value as though it were measured at a second temperature. All acquired resistance measurements can be normalized to the same temperature to assist in comparing different insulation resistance measurements at different times. Combining temperature data and resistance data can include entering the information into an equation or a lookup table stored in memory to determine normalized resistance data. The normalized resistance data can be dependent on the temperature data, the resistance data, and in some examples, supplementary data such as the equipment under test, the material of the insulating element, conductor size and rating, as well as results from other tests or measurements, such as Polarization Index Test and Dielectric Absorption Ratio Testing, or other parameters.

In some examples, a user can input such or other supplementary data via a user interface. Additionally or alternatively, the user can initiate an action such as an additional test or measurement to be performed by the test tool, or another device in communication therewith, via a user interface. The user can input data or other commands in response to any combination of one or more prompts, from a predetermined list of possible selections, or based on the user's own desire to input additional data or commands. In some examples, the determination of normalized resistance data is performed automatically without additional inputs by the user. In some embodiments, the user can include additional information, such as annotation information to provide additional detail or context to the measurement. For instance, the user can input information such as a typical current load or voltage level on the conductor or piece of electrical equipment, nameplate information, location information, time of previous inspections and insulation resistance test times and dates, or other information regarding the insulation resistance measurement or the object under test.

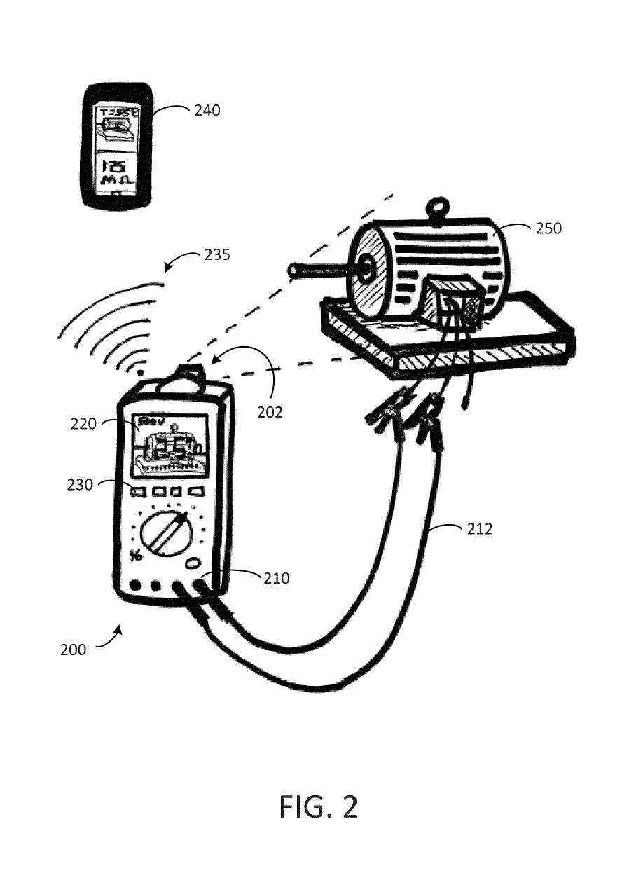

FIG. 2 is a schematic representation of a system including test tool incorporating both a temperature sensing device and a resistance testing device. As shown in FIG. 2, the test tool 200 includes an IR imaging device 202 configured to generate IR image data of a target scene. IR imaging device can be used to determine temperature data of equipment 250 under an insulation resistance measurement. As described previously, the test tool 200 can include a VL imaging device (not shown) for generating VL image data of the target scene. The test tool 200 includes a resistance testing device similar to a DMM, in which inputs 210 can receive leads 212 electrically coupled across equipment to determine the resistance across the equipment 250.

Test tool 200 can receive temperature data from the IR imaging device 202 and resistance data based electrical data at inputs 210 regarding the equipment 250 under an insulation resistance measurement. The test tool 200 can include a processor for combining the received temperature data and resistance data to determine normalized resistance data of the equipment 250 under the insulation resistance measurement. The normalized resistance data can include a resistance value with effects of the temperature of the equipment 250 on the value removed or otherwise accounted for.

In some examples, the processor of the test tool 200 can determine the normalized resistance data based on an equation. The processor can receive resistance data and temperature data and input the received information into the formula in order to determine the normalized resistance data. In other examples, the processor can, based on the received resistance and temperature data, determine the normalized resistance data from a lookup table. In general, the test tool 200 can be configured to receive resistance data and temperature data, and to determine normalized resistance data in substantially real time. The test tool 200 can include memory for storing, for example, the received temperature data, the received resistance data, other received information (e.g., image information from IR imaging device 202), equations, lookup tables, or any other parameters that can be stored in memory for use with the test tool 200.

The test tool 200 can include a display 220 for displaying any combination of resistance data, temperature data, image information, and normalized resistance data. In the illustrated embodiment, the display 220 includes image information and normalized resistance data based on the received resistance data and temperature data. In some examples, the test tool 200 can be configured to generate and display the normalized resistance data on the display 220 in real time. The test tool 200 can include a user interface 230 for allowing a user to adjust any number of parameters regarding test tool 200 operation. For example, a user can adjust which information is displayed on the display 220, or how it is displayed (e.g., a combination of IR and VL image data).

The test tool 200 of the system of FIG. 2 can be in communication with an external device 240, for example, via wireless communication 235. The external device can receive one or both of resistance data and temperature data detected by the test tool. In some embodiments, external device 240 can display any or all of resistance data, normalized resistance data, temperature data, or other available or designated information. The external device 240 can perform analysis on received information, including, for instance, determining normalized resistance data from received resistance data and temperature data. The external device 240 can be used to store any or all of the temperature data, resistance data, or normalized resistance data for future reference. In some examples, any such information can be stored in the cloud by way of the external device 240 or the test tool 200.

In the example of FIG. 2, temperature data is received in the form of infrared image data. In some such examples, infrared image data may be received by an imaging tool integrated into or otherwise attached to the test tool, for example, as described in U.S. patent application Ser. No. 14/855,844, filed Sep. 16, 2015, and entitled “METHOD OF ATTACHING CAMERA OR IMAGING SENSOR TO TEST AND MEASUREMENT TOOLS,” which is assigned to the assignee of the instant application, and which is hereby incorporated by reference in its entirety. In some examples, the test tool can acquire infrared image data (and with it, temperature data) and resistance data substantially simultaneously. In some such embodiments, the test tool can communicate such data substantially simultaneously to an external device. In other examples, temperature data and resistance data are communicated separately to an external device.

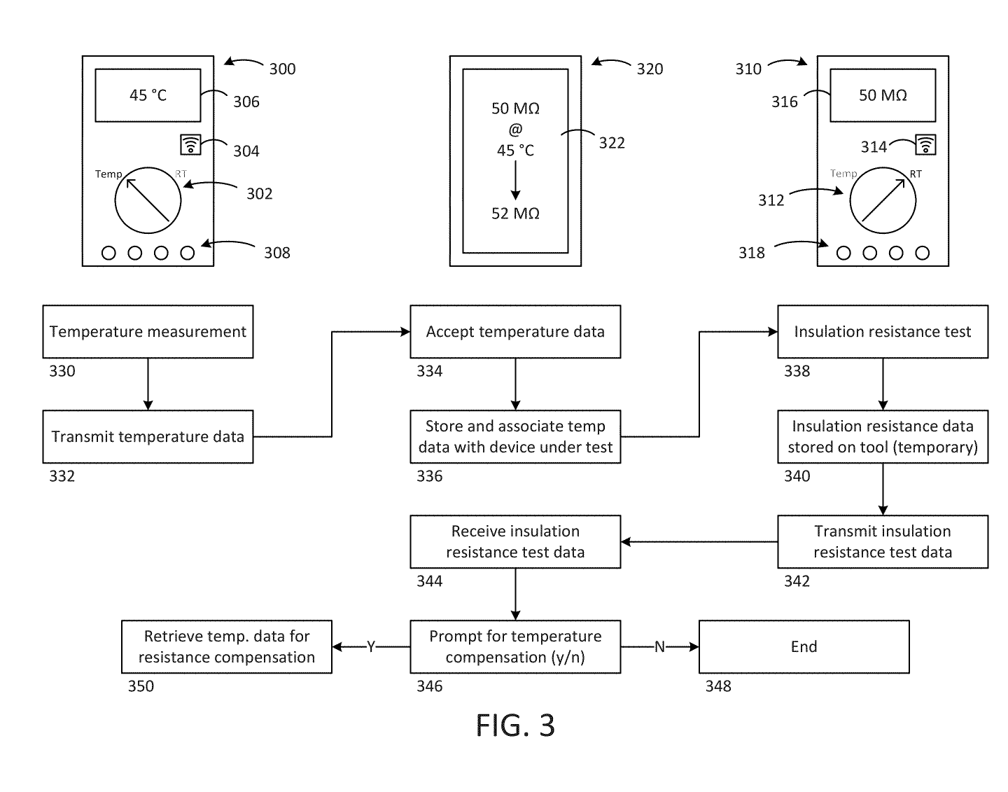

FIG. 3 is a flow diagram illustrating an exemplary process for compensating resistance data with temperature data using an external device. In the illustrated embodiment, a first test tool (e.g., 300) may be used to perform a temperature measurement (330). In the illustrated example, exemplary test tool 300 includes a selection knob 302 for selecting an operating mode of the first test tool 300. As shown, the position of the selection knob 302 on the test tool 300 indicates a temperature measurement. The temperature measurement can be performed via contact or non-contact temperature sensing devices. For example, in some embodiments, the test tool 300 may interface with a contact temperature measurement device such as a thermocouple via ports 308. Non-contact temperature measurement devices could include an infrared camera assembly or other devices mentioned elsewhere herein, for example. Temperature data received by the test tool 300 may be presented on a display 306 for observation by a user. In some examples, the test tool 300 can transmit data via a wired or wireless communication link to an external device (e.g., 320). In the illustrated example, the test tool 300 includes a transmit button 304 configured to initiate the wireless transmission of data between the test tool 300 and an external device. Accordingly, in some examples, the test tool may be used to transmit temperature data (332), for example, to an external device (e.g., 320).

The external device 320 may receive the temperature data (334). The external device 320 may include memory in which to store the received temperature data. In some examples, the external device can store the temperature data and associate the temperature data in memory with an object under test (336). Accordingly, a user may recall the stored temperature data by searching for temperature data associated with a particular device with which the temperature data is associated.

Next, a second test tool (e.g., 310) may be used to perform an insulation resistance test (338). The second test tool 310 includes a selection knob 312 by which a user can select a mode of operation. In the illustrated embodiment, the selection knob 312 of the second test tool 310 indicates a resistance test. The resistance test can be performed, for example, using ports 318, which may be capable of applying and/or measuring electrical signals to perform typical insulation resistance measurements. The test tool 310 can store the insulation resistance data in a memory (340) before transmitting the insulation resistance data (342), for example, to an external device. In some embodiments, the insulation resistance data is stored temporarily on the test tool 310 until it is transmitted to an external device. In some examples, the test tool 300 can transmit data via a wired or wireless communication link to an external device (e.g., 320). In the illustrated example, the test tool 310 includes a transmit button 314 configured to initiate the wireless transmission of data between the test tool 310 and an external device. Accordingly, in some examples, the test tool may be used to transmit temperature data (332), for example, to an external device (e.g., 320).

It will be appreciated that in some embodiments, the first test tool 300 and the second test tool 310 may be the same test tool. For example, the selection knob 302/312 or other interface may be used to select between temperature and insulation resistance measurements. Using such a test tool, during exemplary operation, a user may use the test tool in temperature sensing mode to perform a temperature measurement (330) and transmit the temperature data (332), for example, to an external device. The user can switch the test tool (e.g., via a selection knob) into an insulation resistance testing mode and perform an insulation resistance test (338). The user can use the test tool to transmit the insulation resistance test data (342), for example, to the external device.

The test tool (e.g., 320) can receive the insulation resistance test data (344). In some examples, the external device 320 will prompt the user to determine whether or not to apply a temperature compensation (346). For example, in some embodiments, the external device 320 may provide a binary selection (e.g., yes/no) as to whether or not to perform the compensation. Upon receiving a “no” reply to not perform any temperature compensation, the process ends (348) and the external device may present one or both of the temperature data or uncompensated insulation resistance data on a display 322.

If the user replies “yes” to performing the temperature compensation, the user may be prompted to retrieve temperature data for performing temperature compensation on the received insulation resistance data. In some examples, the user can retrieve temperature data from memory associated with the object under test (e.g., from step 336) for using to compensate the insulation resistance data (350). As described elsewhere herein, compensating the insulation resistance data may include determining what an insulation resistance value for a device would be at a temperature different from the temperature of the object at which the insulation resistance was measured. For example, a compensated insulation resistance value of a device may include a determined insulation resistance value at a predetermined reference temperature. Normalizing the insulation resistance value to a reference temperature may be useful for comparing different insulation resistance measurements or monitoring the insulation resistance of an object over time without requiring the object to be at the same temperature for each measurement.

In various examples, a user need not be prompted whether or not to perform a temperature compensation. For instance, in some examples, provided temperature data and insulation resistance data are known, temperature compensation may be performed automatically in order to normalize the insulation resistance data to a reference temperature. In other examples, a user is not prompted to perform a temperature compensation, but has the option to initiate temperature compensation and to enter temperature data (e.g., manually or from a memory) to use in the compensation determination.

As shown in FIG. 3, the external device 320 includes a display 322 illustrating insulation resistance data, temperature data, and compensated insulation resistance data. In the illustrated example, the temperature measurement (step 330) yielded a measured temperature of 45° C., and the insulation resistance test (step 338) yielded an insulation resistance value of 50 MΩ. Based on the reference temperature (not shown), the temperature-compensated insulation resistance value (i.e., the estimated insulation resistance value if the measurement were taken at the reference temperature) based on the measured temperature is 52 MΩ. It will be appreciated that these values are exemplary and are intended to generally illustrate exemplary operation of the system. The values do not necessarily reflect actual relationships from real data.

It will be appreciated that, while shown in FIG. 3 as taking place on an external device 320, the process of FIG. 3 may be performed entirely on a measurement device. In some embodiments, a measurement device capable of performing such temperature a compensation procedure may communicate any one or more of temperature data, insulation resistance data, and temperature-compensated insulation resistance data to an external device. In various such embodiments, the processing for performing the temperature compensation may take place at the test tool, the external device, or may be split between the two.

As shown in the example of FIG. 3, the normalized resistance data can be presented to the user on a display to indicate the actual resistance value of the insulating element under test. In various embodiments, the normalized resistance data can be displayed on the resistance testing device, the temperature sensing device, or another display, such as a display on one or more portable or external devices such as described in U.S. patent application Ser. No. 14/855,989, which is incorporated herein by reference. In some embodiments, the normalized resistance data is presented to a user automatically once it is determined. In some examples, the displayed information can include one or both of the temperature data and the resistance data in addition to the normalized resistance data.

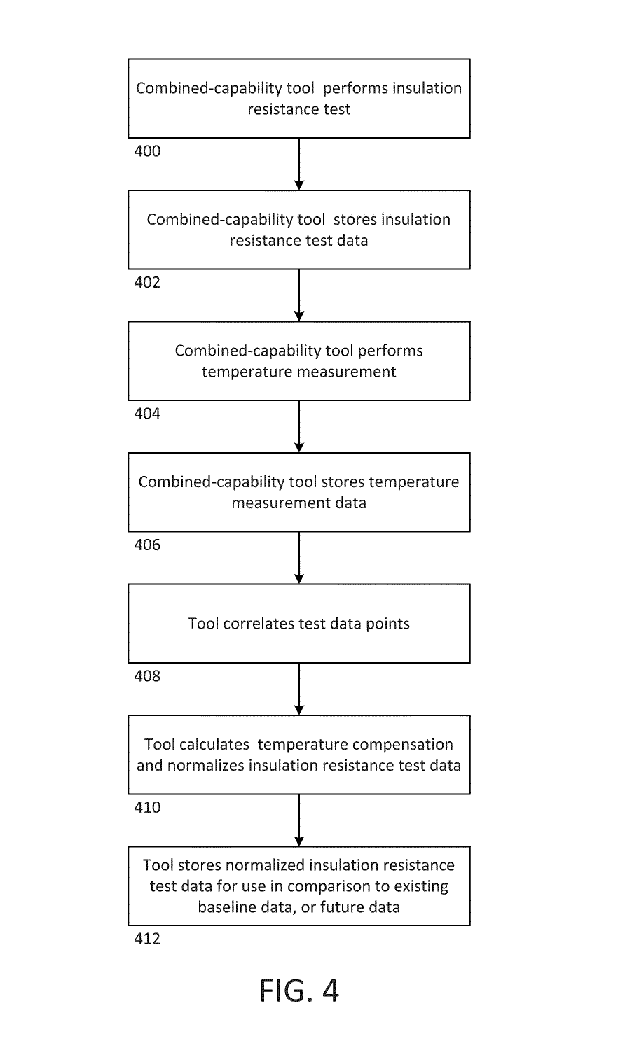

FIG. 4 is a process flow diagram outlining an exemplary process performed by a test tool capable of acquiring both temperature and insulation resistance data. In the exemplary method, a combined-capability tool performs an insulation resistance test (400). The tool stores the insulation resistance in a memory (402). Memory may be built-in to the tool, or may be otherwise in communication the tool via a wired or wireless connection.

The combined capability tool can perform a temperature measurement (404). The temperature measurement may be performed via a contact temperature measurement device (e.g., a thermocouple or resistance temperature detector) or a non-contact temperature measurement device (e.g., an infrared camera or a spot radiometer). The tool can store the temperature measurement data in memory (406). As described with respect to the insulation resistance measurement, memory can be built-in to or otherwise in communication with the tool. The temperature measurement data may be stored in the same or separate memory as the insulation resistance measurement data.

Once the tool has acquired and stored temperature and insulation resistance measurement information, the test tool can correlate test data points (408). That is, the tool can associate a particular temperature measurement data point with a corresponding insulation resistance measurement data point. As such, the temperature measurement data is indicative of the temperature of an object under test at approximately the same time that the insulation resistance measurement data was acquired.

The tool can use the correlated test data points to calculate temperature compensation and normalize insulation resistance test data accordingly (410). As described elsewhere herein, the temperature of an object under test can affect the measured insulation resistance. The temperature compensation calculated by the tool can be used to normalize the measured insulation resistance to a reference temperature. That is, the tool can calculate a value representative of what the insulation resistance would have measured had the insulation resistance measurement been performed at the reference temperature.

The tool can store the normalized insulation resistance test data for future access (412). For example, the compensated insulation resistance test data can be used in a comparison with an existing baseline insulation resistance value (e.g., also normalized to the reference temperature). Additionally or alternatively, the compensated insulation resistance test data can be stored for comparison to future acquired insulation resistance test data. In various embodiments, one or both of the uncompensated insulation resistance test data and the temperature measurement data may be stored along with the compensated insulation resistance test data.

It will be appreciated that various steps shown in FIG. 4 may be permuted or omitted in various embodiments of the invention. For example, in some embodiments, a combined-capability tool can perform the temperature measurement prior to performing the insulation resistance measurement. In some examples, the tool need not necessarily perform both measurements, but may receive one or both of the insulation resistance measurement data and the temperature measurement data from an external source. In some embodiments, a user may manually enter one or both of the temperature measurement data and the insulation resistance measurement data via an interface.

In some embodiments, the tool may transmit any of raw temperature measurement data, insulation resistance measurement data, or compensated insulation resistance data to an external device, such as a smartphone, tablet, computer, or the like. In some examples, the tool can communicate such data to a separate test tool for further use, storage, or trending.

In some embodiments, any one or more of the test initiation steps, data correlation, calculations, or data storage may be performed automatically, for example, by a processor following instructions programmed into a non-transitory computer-readable medium. Similarly, any of such steps may be initiated or performed manually by a user, for example, via a user interface. Any combination of automated and manual steps are possible.

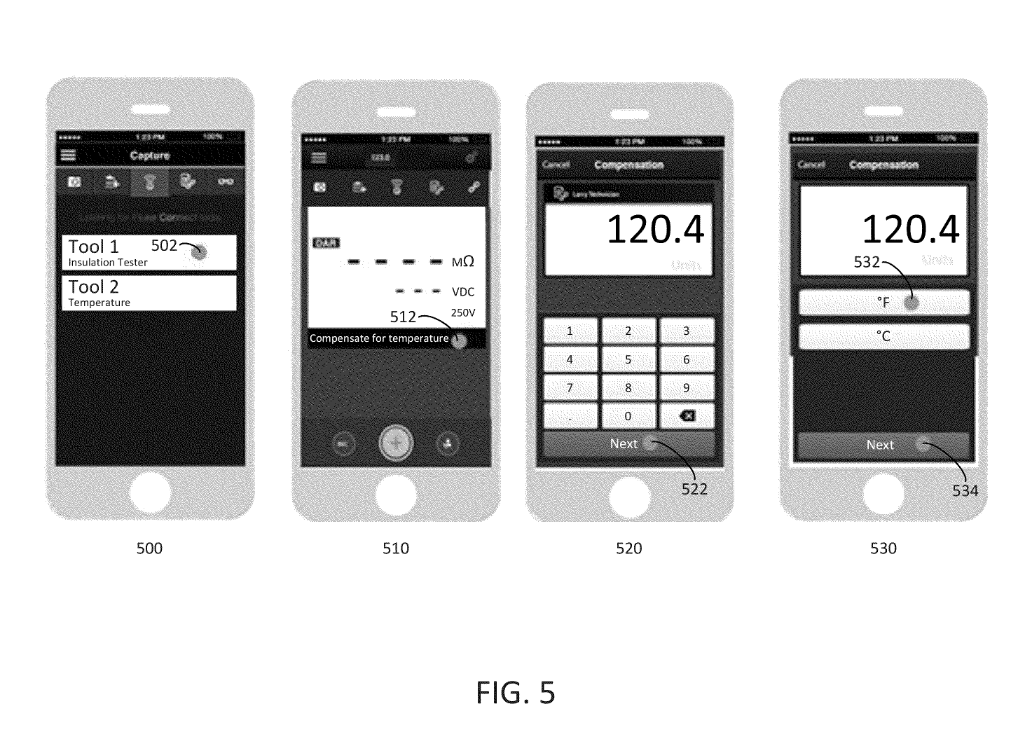

As described, in some examples, one or both of temperature measurement data and insulation resistance test measurement data can be communicated to an external device for processing and/or display. In some embodiments, some data may be communicated to the external device while other data is entered manually by a user. FIG. 5 shows an exemplary method for a combination of automated and manual temperature compensation for an insulation resistance test using an external device. In the illustrated example of FIG. 5, view 500 shows an external device running software (e.g., in the form of an application, or, “app”) which allows a user to select a device from which to acquire data. In the illustrated example, a user may select between Tool 1 and Tool 2. The display includes a description of the tools, such as “Insulation Tester” and “Temperature” to assist a user in selecting which tool they are selecting to receive information from. Any number of devices may be selectable by a user. Spot 502 indicates a selection by the user (e.g., via an interface such as a mouse or touchscreen) of Tool 1.

View 510 of FIG. 5 is an exemplary landing screen after selecting Tool 1 in view 500. As shown, Tool 1 corresponds to an insulation tester. Accordingly, view 510 includes various spaces for data related to an insulation resistance test to be displayed, such as a resistance value (in MΩ), an applied voltage (in VDC) and an applied voltage range (shown as 250V). In some examples, in the course of acquiring insulation test resistance data, a user may choose to compensate for temperature. Spot 512 in view 510 indicates a user selecting to compensate for temperature.

View 520 shows a possible landing page for a user having selected to compensate for temperature in view 510. In the illustrated embodiment, the display includes a keypad for the user to manually enter a temperature associated with an object under test. A user may enter a temperature, for example, based on temperature data received from a temperature measurement device. In some examples, the user may use the same external device for viewing temperature data, such as by selecting Tool 2 (Temperature) in view 500. The user may enter a temperature (120.4 in the illustrated embodiment) and continue by pressing the “Next” button, shown as selected via spot 522.

Once a user has entered a temperature, the external device may prompt the user to enter the units associated with the entered temperature, such as shown in view 530. As shown, the user may select from ° F. and ° C. as temperature units corresponding to input temperature data. As shown, a user selects ° F. with spot 532, indicating a temperature of 120.4° F. for the object under test. After a user enters the temperature and units, for example, by pressing “Next” indicated by spot 534, the tool may use the entered temperature data to compensate for a difference between the entered temperature and a reference temperature by normalizing a measured insulation resistance test value to the reference temperature. In some examples, a reference temperature may be entered using a similar interface as shown in views 520 and 530.

While shown as being manually entered in FIG. 5, it will be appreciated that in some examples, temperature measurement data may be acquired automatically using a temperature measuring device in communication with the external device shown. Additionally or alternatively, temperature measurement data may be stored in device memory and accessible by a user for entry into a temperature compensation process.

As described elsewhere herein, compensating for variations in temperatures by normalizing an insulation resistance test value to a reference temperature may assist in comparing insulation resistance values among different objects under test or trending insulation resistance values of a single object under test over time. The compensated insulation resistance test values may be determined, for example, by performing a calculation using the measured insulation resistance value, the measured temperature, and the reference temperature. In some examples, a lookup table may be stored in memory that correlates temperatures, measured insulation resistance values, and reference temperatures to compensated insulation resistance values.

Table 1 shows a plurality of insulation resistance tests of an object under test taken at different times and temperatures. The table includes, for each separate time, the measured insulation resistance (in MΩ), the temperature (in ° C.), the temperature compensation factor associated with the temperature, and the temperature-adjusted insulation resistance (in MΩ). In the example of Table 1, the temperature compensation factor, KT, is determined by the equation:

KT=(0.5)̂((T_{R}−T_{A})/10)

wherein T_{A} is the measured test temperature in ° C. and T_{R} is the reference temperature in ° C. to which measurements are normalized, in this case 40° C. The temperature adjusted insulation resistance value can then be determined by the equation:

Temperature Adjusted Insulation Resistance=Measured Insulation Resistance×KT

TABLE 1

| | | | | Temperature |
|---|---|---|---|---|
| | Measured | | Temperature | Adjusted |
| | Insulation | | Compensation | Insulation |
| | Resistance | Temperature | Factor | Resistance |
| Time | (MΩ) | (° C.) | KT | (MΩ) |
| Time 1 | 1584.3 | 42 | 1.15 | 1821.9 |
| Time 2 | 1025.3 | 48 | 1.74 | 1784.0 |
| Time 3 | 1867.2 | 39 | 0.93 | 1736.5 |
| Time 4 | 1388.4 | 43 | 1.23 | 1707.7 |
| Time 5 | 2035.3 | 37 | 0.81 | 1648.6 |
| Time 6 | 1156.4 | 45 | 1.41 | 1630.5 |
| Time 7 | 1503.2 | 41 | 1.07 | 1608.4 |
| Time 8 | 1224.3 | 43 | 1.23 | 1505.9 |
| Time 9 | 1604.9 | 39 | 0.93 | 1492.6 |
| Time 10 | 1123.6 | 43 | 1.23 | 1382.0 |
| Time 11 | 821 | 47 | 1.62 | 1330.0 |
| Time 12 | 1245.7 | 40 | 1.00 | 1245.7 |

As can be seen in table 1, the measured insulation resistance values do not trend in any particular direction over time. That is, there is no definite evidence of the insulation resistance of the device under test changing in a meaningful way based on the uncompensated measured insulation resistance values. However, after determining corresponding temperature adjusted insulation resistance values, it can be seen that the adjusted insulation resistance values trend downward with time. That is, over time, the insulation resistance of the device under test diminishes.

As described herein, various information can be presented to a user for display. For example, at least one of a test tool or external device can be used to display one or more of measured insulation resistance data, temperature data, and normalized insulation resistance data. In some embodiments, a variety of supplementary information can be displayed in addition to any of the normalized resistance data, the resistance data, or the temperature data. For example, the test tool can append such supplemental information into the display in order to present additional information to a current user or to someone referencing captured data in the future. In some examples, the test tool appends information such as location information or a nameplate photograph to the primary measurement information (e.g., resistance data, temperature data, and normalized resistance data). The results of other related tests or measurements can be appended to the primary measurement information. In addition, previous past measurements can be recalled and linked to current measurement data for comparison. Such supplementary information can be acquired by the test tool itself (e.g., by embedded or appended features such as a GPS device, or radio- or spatial-positioning components), or can be received from other devices or networks in communication with the test tool (e.g., other tools, wireless networks, the cloud, etc.).

In some embodiments, the test tool can be configured to append such supplementary information to primary measurement information whenever the supplementary information is available. In other embodiments, supplementary information is appended at the request of a user. Similarly, in various embodiments, the acquisition of such supplementary data can be initiated automatically or by a user. In some embodiments, a user can toggle the appearance of supplementary information on the display, and in further embodiments, can select which from a group of supplementary information to display. Accordingly, the display can include any combination of resistance data, temperature data, normalized resistance data, and any set or subset of available supplementary information appended to or otherwise associated with the primary measurement information.

The normalized resistance data can be stored in memory, for instance, in a normalized resistance database, to observe trends or values of the normalized resistance over time. In some examples, the normalized resistance data is stored with corresponding non-normalized resistance data and temperature data, so that each of such parameters can be recalled in the future. Associated supplementary information can be appended to or stored with the primary measurement information. In various examples, various pieces of information (e.g., resistance data, temperature data, normalized resistance data, supplementary information, etc.) need not be stored in the same physical location. That is, various pieces of information can be stored in one or more locations accessible by a common device for any performed collection or combination of such information for calculations, comparisons, or display.

Normalized resistance data can provide a consistent baseline for an insulation resistance measurement. Accordingly, insulation resistance measurements can be compared more uniformly with other insulation resistance measurements performed in the past. That is, the insulation resistance of particular equipment can be monitored over time, and because of the normalization for temperature variation, can be more meaningfully compared than non-normalized data taken at various times and unknown temperatures. Additionally, normalized resistance data can enable side-by-side analysis of similar equipment, but operating at different temperatures. For instance, the resistance of various insulating elements in a piece of electrical equipment can be compared to one another during operation regardless of the operating temperature of each insulating element.

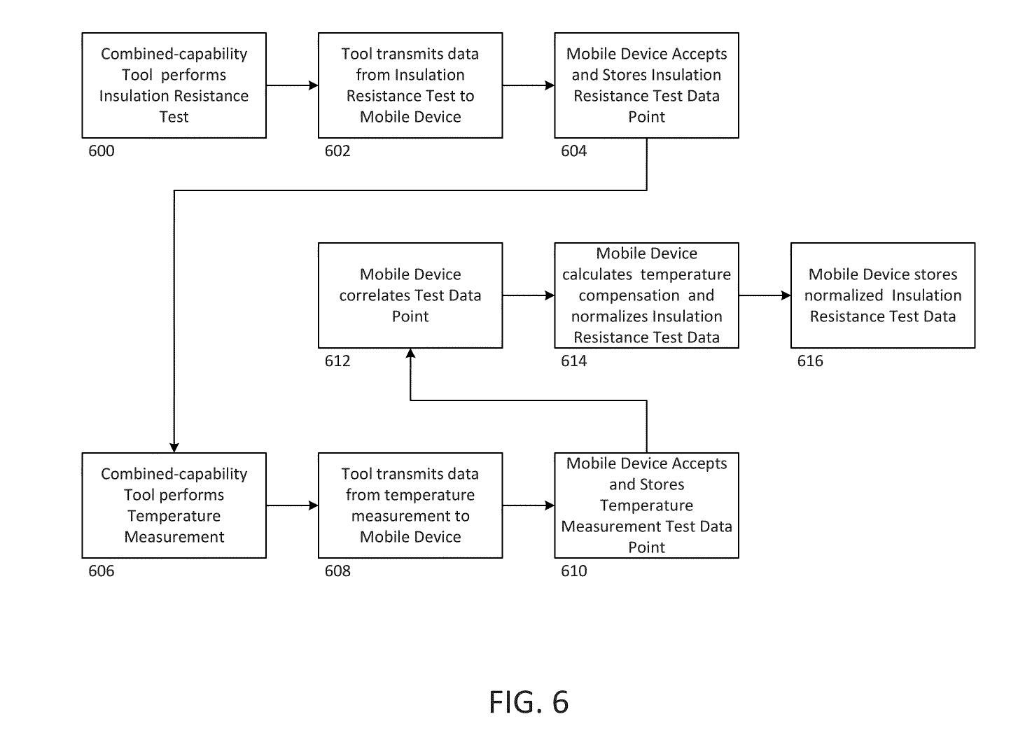

Various systems and methods for acquiring and combining insulation resistance data and temperature data in order to normalize the insulation resistance data to a reference temperature. For example, FIG. 4 is a process flow diagram outlining an exemplary process performed by a test tool capable of acquiring both temperature and insulation resistance data. As described elsewhere herein, other configurations and processes are possible. FIGS. 6-11 are exemplary process flow diagrams showing different processes for acquiring and combining temperature and insulation resistance data for determining a normalized insulation resistance value.

FIG. 6 is a process flow diagram illustrating operation of a combined test tool with sequential testing and mobile device correlation and computation. In the illustrated example, a single combined-capability test tool performs an insulation resistance test (600) and transmits data from the test to a mobile device (602) which accepts and stores the insulation resistance test data (604). Similarly, the single combined-capability test tool performs a temperature measurement (606) and transmits data from the measurement to the mobile device (608) which accepts and stores the temperature measurement data (610). While shown as performing the insulation resistance test (600) prior to the temperature measurement (606), such measurement steps may be performed in either order. The mobile device correlates the insulation resistance and temperature data points (612), calculates temperature compensation and normalizes the insulation resistance test data (614). The mobile device stores the normalized insulation resistance test data (616), for example, for future comparative or trending analysis.

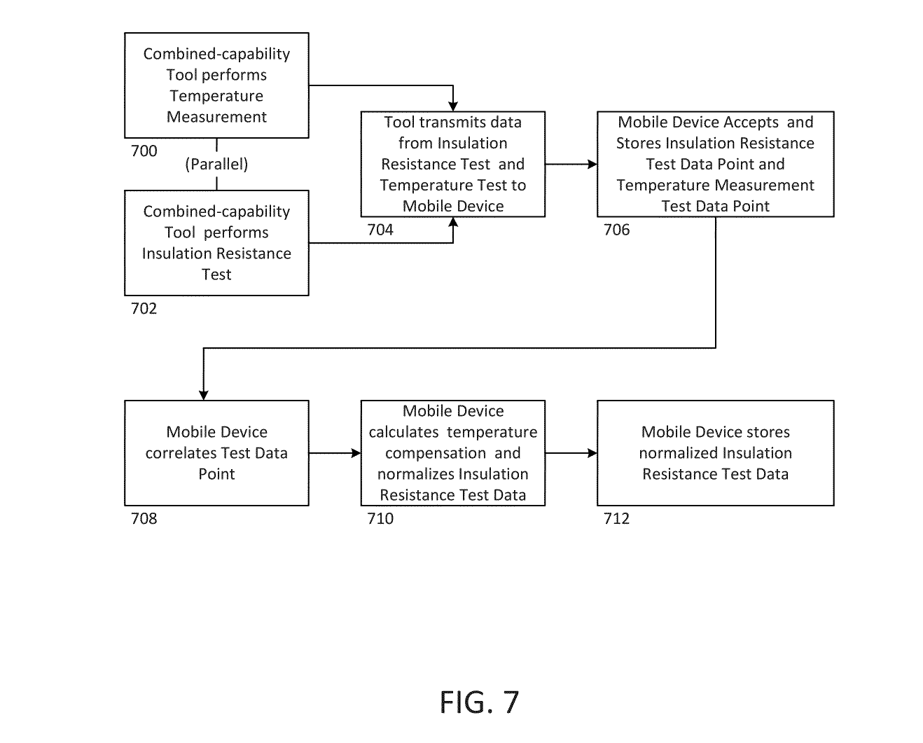

FIG. 7 is a process flow diagram illustrating operation of a combined test tool with simultaneous or parallel testing and mobile device correlation and computation. In the illustrated example, a combined capability tool performs a temperature measurement (700) and an insulation resistance test (702) in parallel. The tool transmits data from the insulation resistance test and the temperature measurement test to a mobile device (704). The mobile device accepts and stores both the insulation resistance test and the temperature measurement (706) and correlates the test data (708). The mobile device calculates temperature compensation and normalizes the insulation resistance test data (710). The mobile device stores the normalized insulation resistance test data (712), for example, for future comparative or trending analysis.

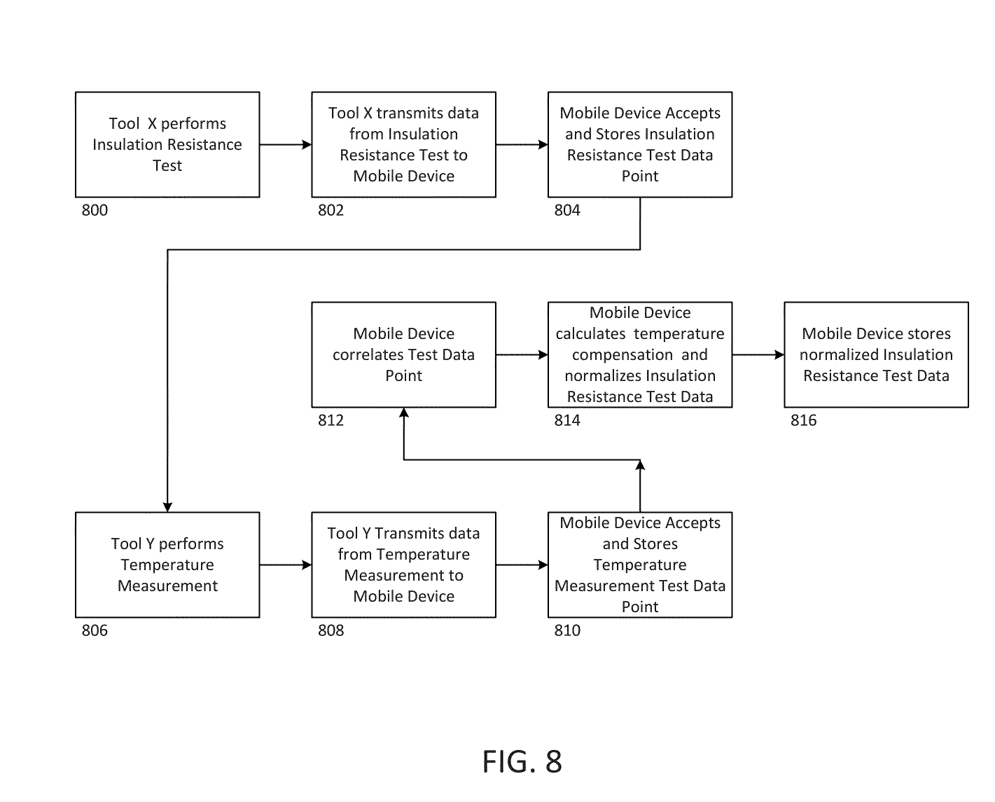

FIG. 8 is a process flow diagram illustrating operation of separate test tools with sequential testing and mobile device correlation and computation. In the illustrated example, Tool X performs an insulation resistance test (800) and transmits data from the insulation resistance test to a mobile device (802). The mobile device accepts and stores the insulation resistance test data point (804). Similarly, Tool Y performs a temperature measurement (806) and transmits data from the temperature measurement to the mobile device (808). The mobile device accepts and stores the temperature measurement test data point (810). While Tool X is shown as performing the insulation resistance test (800) prior to Tool Y performing the temperature measurement (806), such measurement steps may be performed in either order.

The mobile device correlates the insulation resistance and temperature data points (812), calculates temperature compensation and normalizes the insulation resistance test data (814). The mobile device stores the normalized insulation resistance test data (816), for example, for future comparative or trending analysis.

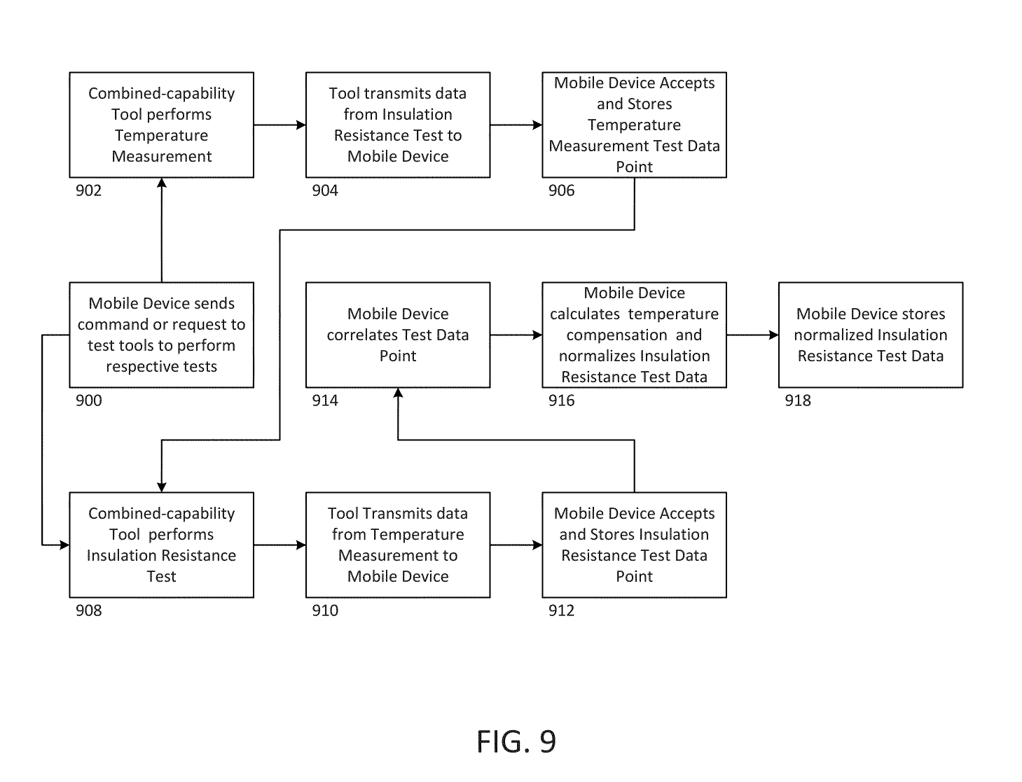

FIG. 9 is a process flow diagram illustrating operation of mobile device initiated separate test tools with sequential testing and mobile device correlation and computation. In the illustrated example, a mobile device sends a command or request to a combined-capability test tool to perform respective tests (900). The combined-capability test tool performs an insulation resistance test (902) and transmits data from the test to a mobile device (904) which accepts and stores the insulation resistance test data (906). Similarly, upon receiving the command from the mobile device, the single combined-capability test tool performs a temperature measurement (908) and transmits data from the measurement to the mobile device (910) which accepts and stores the temperature measurement data (912). While shown as performing the insulation resistance test (902) prior to the temperature measurement (908), such measurement steps may be performed in either order. The order may depend on the command from mobile device, for example. The mobile device correlates the insulation resistance and temperature data points (914), calculates temperature compensation and normalizes the insulation resistance test data (916). The mobile device stores the normalized insulation resistance test data (918), for example, for future comparative or trending analysis.

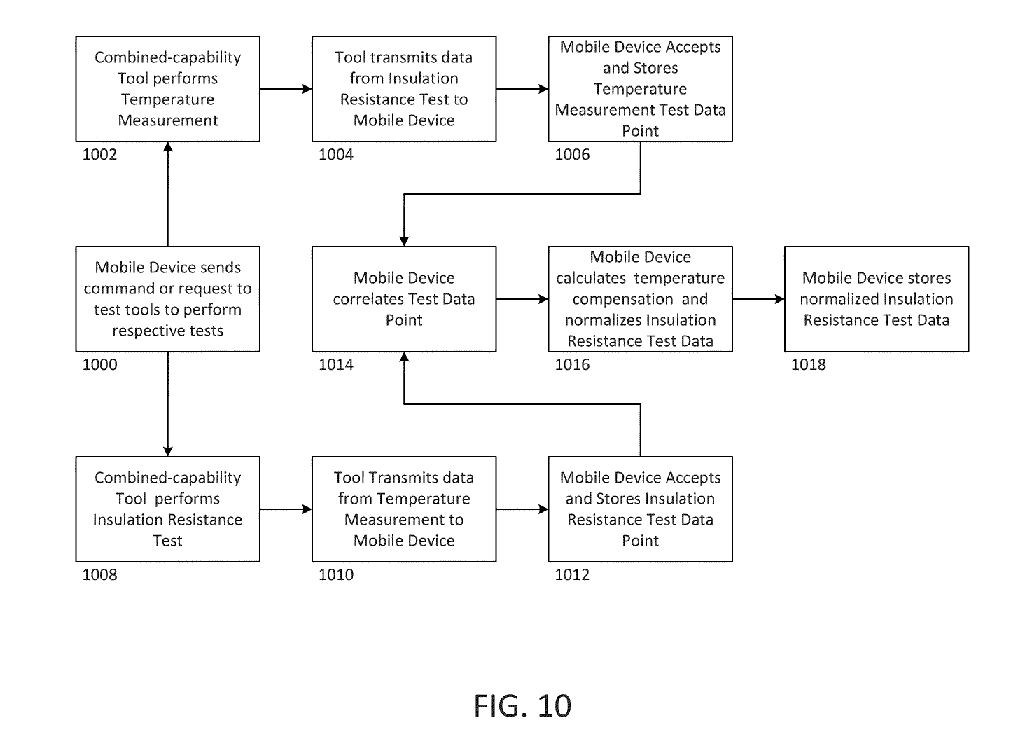

FIG. 10 is a process flow diagram illustrating operation of mobile device initiated separate test tools with simultaneous or parallel testing and mobile device correlation and computation. In the illustrated example, a mobile device sends a command or request to a combined-capability test tool to perform respective tests (1000). The combined capability tool performs a temperature measurement (1002) and an insulation resistance test (1008) in parallel. The tool transmits data from the insulation resistance test and the temperature measurement test to a mobile device (1004, 1010). The mobile device accepts and stores both the insulation resistance test and the temperature measurement (1006, 1012) and correlates the test data (1014). The mobile device calculates temperature compensation and normalizes the insulation resistance test data (1016). The mobile device stores the normalized insulation resistance test data (1018), for example, for future comparative or trending analysis.

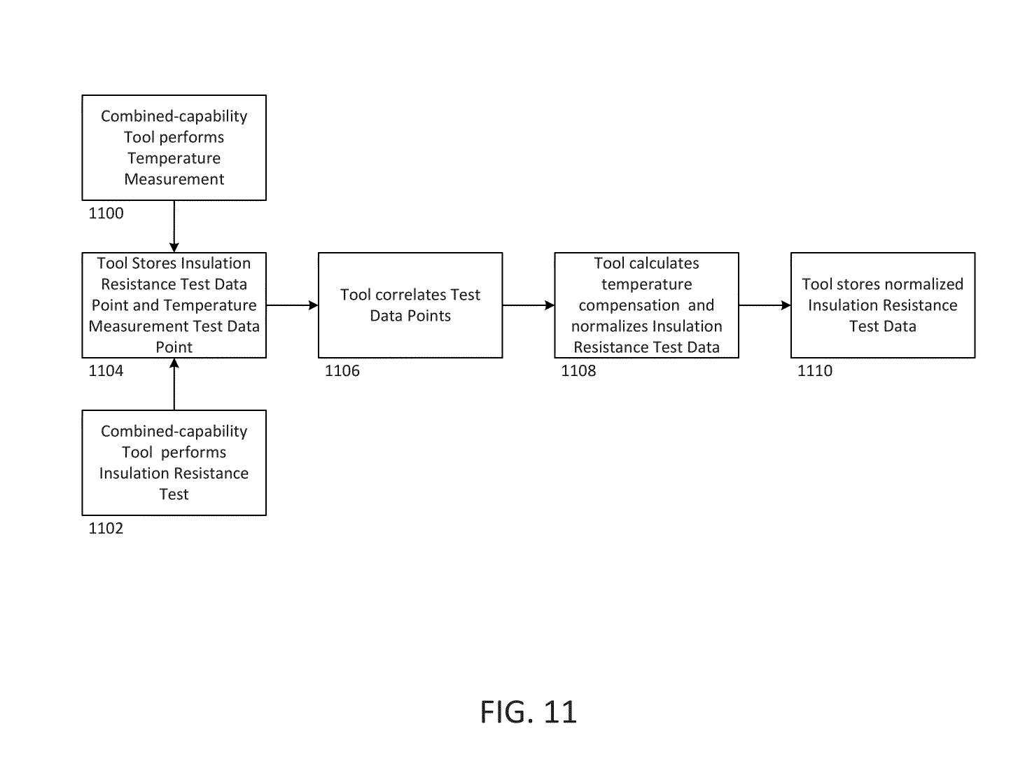

FIG. 11 is a process flow diagram illustrating operation of a combined test tool with simultaneous or parallel testing and in-tool correlation and computation. In the illustrated example, a combined capability tool performs a temperature measurement (1100) and an insulation resistance test (1102) in parallel. The tool stores the insulation resistance test data point and the temperature measurement test data point (1104) and correlates the test data points (1106). The tool calculates temperature compensation and normalizes the insulation resistance test data (1108) and stores the normalized insulation resistance test data (1110), for example, for future comparative or trending analysis.

In the various examples described in FIGS. 6-11, storing and analysis of data points is described. For example, a single temperature measurement and a single insulation resistance test can be combined to yield a single normalized insulation resistance value. In some embodiments, such a process can be performed repeatedly in order to generate a dynamically updating and substantially real-time normalized insulation resistance value.

Various embodiments have been described. Such examples are non-limiting, and do not define or limit the scope of the invention in any way. Rather, these and other examples are within the scope of the following claims.

1. A system for performing an insulation resistance measurement comprising:
a resistance testing device configured to generate resistance data regarding the insulation resistance of equipment under test;
a temperature sensing device configured to generate temperature data regarding the temperature of the equipment under test;
a processor configured to receive the resistance data from the resistance testing device, receive temperature data, and determine, based on the received resistance data and temperature data, normalized resistance data accounting for temperature effects on the measured resistance; and
a display for presenting the normalized resistance data to a user.

2. The system of claim 1, wherein the resistance testing device and the temperature sensing device are combined in a single test tool.

3. The system of claim 1, wherein the temperature sensing device comprises an infrared (IR) imaging device.

4. The system of claim 3, wherein the IR imaging device is built in to the resistance testing device.

5. The system of claim 1, wherein the resistance testing device comprises an insulation resistance tester.

6. The system of claim 1, wherein the processor is configured to generate display information to present the normalized resistance data on the display in substantially real time.

7. The system of claim 1, wherein the resistance testing device and the temperature measuring device are separate devices, and are in communication via a wired or wireless communication link.

8. The system of claim 1, wherein the normalized resistance data is generated from one of an equation or a lookup table.

9. The system of claim 1, further comprising a user interface in communication with the processor, and wherein the processor is configured to determine the normalized resistance data in response to an input via the user interface.

10. The system of claim 9, configured to prompt a user whether or not to determine normalized resistance data.

11. The system of claim 9, wherein the received temperature data is received via the user interface.

12. The system of claim 1, wherein the processor receives the received temperature data directly from the temperature sensing device and automatically determines the normalized resistance data.

13. The system of claim 1, further comprising an external device comprising the processor, and wherein the external device receives resistance data from the resistance testing device via a wireless communication link.

14. The system of claim 13, wherein the external device comprises one or more of a smartphone, a tablet, or a computer.

15. The system of claim 1, wherein determining normalized resistance data comprises determining an estimated resistance value of the equipment under test at a reference temperature.

16. An insulation resistance testing system comprising:
a combination tool comprising:
an insulation resistance testing tool capable of performing an insulation resistance test to generate insulation resistance data of an insulating element;
a temperature measurement tool configured to generate temperature data representative of a device under test; and
a processor configured to receive insulation resistance data, temperature data, and a reference temperature and to determine normalized insulation resistance data comprising a resistance value of the insulating element at the reference temperature.

17. The insulation resistance testing system of claim 16, further comprising memory in communication with the processor and wherein the processor is configured to store at least the normalized insulation resistance data and the reference temperature in memory.

18. The insulation resistance testing system of claim 17, wherein a plurality of normalized insulation resistance data normalized to a like reference temperature are associated and stored in memory for insulation resistance monitoring of the insulating element over time.

19. The insulation resistance testing system of claim 16, wherein the processor is included in an external device in wireless communication with the combination tool.

20. The insulation resistance testing system of claim 19, wherein the external device receives insulation resistance data from the combination tool via wireless communication.

21. A method comprising:
receiving resistance data regarding the insulation resistance of an insulating element;
receiving temperature data regarding the temperature of the insulating element;
receiving a reference temperature; and
based on the received resistance data, temperature data, and reference temperature, determining normalized resistance data representative of a resistance value of the insulating element at the reference temperature.

22. The method of claim 21, wherein the receiving the temperature data comprises receiving temperature data via a user input.

23. The method of claim 21, wherein the receiving the resistance data comprises receiving resistance data via a wireless communication link.
